(19) United States
(12) Patent Application Publication
(10) Pub. No.: US 2013/0075035 A1
(43) Pub. Date: Mar. 28, 2013

(54) CUSHION MATERIAL FOR HOT-PRESS AND USE OF THE SAME

(71) Applicant: Chun-Chih Huang, New Taipei City (TW)

(72) Inventor: Chun-Chih Huang, New Taipei City (TW)

(73) Assignee: TECH ADVANCE INDUSTRIAL CO., LTD., New Taipei City (TW)

(21) Appl. No.: 13/309,588

(22) Filed: Dec. 2, 2011

(30) Foreign Application Priority Data
Sep. 22, 2011 (TW) 100134125

(51) Int. Cl. D04H 3/105; B32B 37/00

(52) U.S. Cl. 156/306.3; 442/402; 428/219

(57) ABSTRACT

A cushion material for a hot-press is provided. The cushion material comprises: a substrate; and a fiber material, the thermal conductivity coefficient of which is lower than about 0.15 W/m·K at about 20° C. and increases with increasing temperature, for example, the thermal conductivity coefficient may be higher than about 0.20 W/m·K at about 160° C., wherein the fiber material is needle-punched on the substrate.

This application claims priority to Taiwan Patent Application No. 100134125 filed on Sep. 22, 2011.

### CROSS-REFERENCES TO RELATED APPLICATIONS

Not applicable.

### BACKGROUND OF THE INVENTION

1. Field of the Invention

The present invention relates to a cushion material for a hot-press and use of the same. Specifically, the present invention relates to a cushion material with a low thermal conductivity coefficient at a low temperature and a high thermal conductivity coefficient at a high temperature and use of the same.

2. Descriptions of the Related Art

Laminates, such as flexible printed circuit boards (FPCBs), IC substrates, multi-layered wiring boards, circuit printed boards (PCBs), copper clad laminates or high density interconnections (HDIs), are build-up layer structures formed by hot-pressing process. For example, printed circuit boards can be prepared by adhering a plurality of prepregs, insulation layers, adhesive layers and metal layers through hot-pressing process. During hot-pressing, the thermal and pressure control is very important because it influences both the adhesion between the layers of the prepared laminate and the physical and electric properties of the prepared laminate.

The preparation of a laminate is illustrated below with reference to FIG. 1. As shown in FIG. 1, a hot-press 1 comprises heating plates 111, carrier plates 131, cushion materials 151 and steel plates 171 disposed sequentially as well as build-up layers 191 placed between the steel plates 171. The steel plates 171 provide a hot-pressing effect when a specific pressure and heat are applied to hot-press 1 through the heating plates 111. With the use of the cushion materials 151, the applied pressure and heat can be uniformly transferred to the outer surfaces of the build-up layers 191 to provide a laminate with good precision.

The cushion material 151 has to meet certain requirements, such as a cushion ability for absorbing the pressure from upper and lower heating plates 111 and/or carrier plates 131, a temperature-buffering ability for the non-uniform temperature distribution of the heating plates 111, and an ability for uniformly transferring the heat and pressure from the heating plates 111.

Kraft papers are commonly used as the cushion material since they are inexpensive and capable of uniformly transferring heat. However, kraft papers also have many disadvantages such that the tensile strength of the kraft paper under hot-pressing conditions at a high temperature (such as 150° C.) is less than 20% of that at room temperature and the modulus of elasticity of kraft paper at a high temperature is even lower than 250 Mpsi. In addition, as a cushion material, kraft papers cannot be reused because the kraft papers will deteriorate causing increased heat resistance and thereby decrease the heat transferring ability of the cushion material; as a result, the kraft papers are neither eco-friendly nor economical.

Presently, some reusable cushion materials have been developed. For example, JP 55-101224 B discloses a needle punched multi-layer felt-like cushion material composed of aromatic polyamide fibers, wherein the aromatic polyamide fibers can be mixed-spun with fluorine-based fibers, glass fibers, metal fibers, carbon fibers and other heat-resistant fibers. TW 1231265 discloses a reusable cushion material, which is provided by combining two kinds of fibers with different properties. TW 1318924 discloses a cushion material formed by the fiber with a core/shell structure, wherein the core of the fiber has a softening temperature lower than the hot-pressing temperature, while the shell of the fiber has a softening temperature higher than the hot-pressing temperature so as to maintain the cushion ability under the hot-pressing cycles.

Conventional modifications on the cushion material are all directed to reusability and thermal conductivity. However, the cushion material with a high thermal conductivity will result in “resin overflow” in practice. The term “resin overflow” means that when the thermal conductivity coefficient of the cushion material is too high, the heat transfer is too fast that the resin of the build-up layers will soften and overflow in the initial stage of the hot-pressing operation (i.e. a low temperature stage where the resin remains in a half-hardened state) and consequently contaminate the surface of the cushion material. Even more so, if the resin overflow severely occurs, the prepared laminate may have a nonuniform thickness distribution and thus, the production stability will be considerably affected.

In view of the above, the present invention provides a reusable cushion material, which has a low thermal conductivity coefficient at a low temperature and a high thermal conductivity coefficient at a high temperature, and is capable of resolving the problem of resin overflow.

### SUMMARY OF THE INVENTION

An aspect of the present invention is to provide a cushion material, comprising a substrate and a fiber material, wherein the fiber material has a thermal conductivity that is lower than about 0.15 W/m·K at about 20° C. and increases with increasing temperature, and wherein the fiber material is needle-punched on the substrate.

Another aspect of the present invention is to provide a method for manufacturing a laminate, comprising hot-pressing a plurality of build-up layers by a hot-pressing device, wherein the said cushion material is present between the hot-pressing device and the build-up layers.

To render the above objects, technical features and advantages of the present invention more apparent, the present invention will be described in detail with reference to some embodiments hereinafter.

### BRIEF DESCRIPTION OF THE DRAWINGS

FIG. 1 shows a schematic profile of a hot-press;

FIG. 2 shows a schematic profile of another hot-press; and

FIG. 3 shows a schematic profile of still another hot-press.

### DESCRIPTION OF THE PREFERRED EMBODIMENT

The following will describe some embodiments of the present invention in detail. However, without departing from the spirit of the present invention, the present invention may be embodied in various embodiments and should not be limited to the embodiments described in the specification. In addition, unless it is additionally explained, the expressions “a,” “the,” or the like recited in the specification (especially in the claims) should include the singular and the plural forms. Furthermore, for clarity, the size of each element and each area may be exaggerated in the attached drawings and is not depicted to their actual scale.

The present invention provides a cushion material, which has a low thermal conductivity coefficient at a low temperature and a high thermal conductivity coefficient at a high temperature. Specifically, the cushion material of the present invention is formed by needle-punching a fiber material on a substrate, wherein the thermal conductivity coefficient of the fiber material is lower than about 0.15 W/m·K at about 20° C. and increases with increasing temperature. For example, the thermal conductivity coefficient of the fiber material may be higher than about 0.20 W/m·K at about 160° C. With the thermal conductivity characteristic and cushion ability of the fiber material, the cushion material of the invention can provide a suitable thermal conductivity at a low temperature heating stage (the initial stage of the hot-pressing operation) to avoid “resin overflow” and provide a high thermal conductibility at a high temperature heating stage to shorten the hot-pressing duration in the meanwhile without changing the hot-pressing condition of a hot-press.

In addition to the desired thermal conductivity characteristic as described above, the fiber material of the cushion material of the present invention needs to have a thermal degradation temperature higher than the highest temperature applied during the production of laminates, and preferably higher than 350° C. For example, poly-paraphenylene terephthalamide (PPTA), which has a thermal degradation temperature of 427° C. and a thermal conductivity coefficient ranging from about 0.06 to about 0.12 W/m·K at low temperature (about 10° C. to 30° C.) and about 0.23 to about 0.29 W/m·K at about 160° C., can be used as the fiber material of the cushion material of the present invention.

In addition to the fiber with the desired thermal conductivity coefficient, the fiber material of the cushion material of the present invention can further comprise other fiber(s) to impart the cushion material with other properties. For example, the fiber material of the cushion material of the present invention may be essentially composed of a PPTA fiber and a fiber selected from a group consisting of a poly-metaphenylene isophtalamide (MPIA) fiber, a heteroatom-containing aromatic fiber, an aromatic heterocyclic fiber, a graphitized carbon fiber, a novolac fiber (Kynol), a melamine formaldehyde (MF) fiber, a polytetrafluoroethylene (PTFE) fiber, a Visit fiber and combinations thereof. In some embodiments of the present invention, the illustrated fiber material was essentially composed of a PPTA fiber or a PPTA fiber in combination with a MPIA fiber. The MPIA fiber is useful for adjusting the thermal conductivity of the cushion material at a high/low temperature to meet the users' requirements due to its outstanding cushion ability and thermal conductivity coefficient characteristic which is higher than that of a PPTA fiber at a low temperature but lower than that of a PPTA fiber at a high temperature. As long as the fiber combination can provide a fiber material with a desired thermal conductivity coefficient, there is no special limitation on the combining ratio of fibers. For example, in the embodiment where the fiber material is provided by a PPTA fiber in combination with a MPIA fiber, the amount of the MPIA fiber preferably ranges from about 5 wt % to about 45 wt % based on the total weight of the fiber material.

In the cushion material of the present material, the substrate is used for providing a structural support for fixing the fiber material and maintaining its orientation. There is no special limitation on the structure of the substrate; for example, it can be in a form of a net, a fabric, a sheet, etc. Also, there is no special limitation on the material of the substrate except that its thermal degradation temperature should be higher than the highest temperature applied during the preparation of a laminate, and preferably higher than 350° C.

For example, the substrate of the cushion material of the present invention can be essentially composed of a fiber selected from a group consisting of a PPTA fiber, a MPIA fiber, a heteroatom-containing aromatic fiber, an aromatic heterocyclic fiber, a graphitized carbon fiber, a Kynol fiber, a MF fiber, a PTFE fiber, a glass fiber, a Visit fiber and combinations thereof. Preferably, the substrate is composed of a fiber shrinkable at a high temperature (for example, at about 180° C.) and thus, can fix the fiber material more tightly during the hot-pressing operation at a high temperature to prevent the fibers (which form the fiber material) from dropping while increase the thermal transfer of the cushion material at a high temperature.

It is found that the MPIA fiber shrinks with increasing temperature and thus is very suitable for the substrate of the cushion material of the present invention. In some embodiments of the present invention, the substrate is a fibrous net composed of a MPIA fiber and the fiber material is needle-punched on the substrate.

The thermal conductivity of the cushion material of the present invention is also correlated to the basis weight of the cushion material, in addition to the properties of the fiber material. In general, under the same heating conditions, the lower the basis weight of a cushion material, the lower the thermal resistance of the cushion material and the higher the heat transferring rate of the cushion material; on the contrary, the higher the basis weight of a cushion material, the higher the thermal resistance of the cushion material and the lower the heat transferring rate of the cushion material. Therefore, the basis weight of the cushion material of the invention can optionally be regulated to meet the temperature controlling requirements (the temperature raising/reducing rate) of each hot-pressing process.

Generally, the cushion material of the present invention has a basis weight ranging from about 200 g/m² to about 3000 g/m², preferably from about 1400 g/m² to about 2200 g/m², but not limited thereto. Depending on the process requirements, persons with ordinary skill in the art can choose any suitable basis weight based on the disclosure of the present invention and their knowledge in the art. In some embodiments of the present invention, the illustrated cushion material has a basis weight of about 1600 g/cm². In addition, a desired basis weight of the cushion material can be provided by, for example, adjusting the diameter or the density of the fibers of the fiber material, or by combining a plurality of pre-needle punched cushion sheets with each other. Persons with ordinary skill in the art can optionally adjust the basis weight of a cushion material based on their technological knowledge in the art and the disclosure of the present invention.

Depending on the needs, the cushion material of the present invention can be applied to a hot-pressing treatment in single piece or in multiple pieces. When multiple pieces of the cushion materials are applied, the constitution (i.e., different substrate and/or fiber material) and/or basis weight of the cushion materials may be different from or the same as each other so as to provide desired thermal transfer and cushion properties.

Furthermore, for protection or other purposes (such as to facilitate the transportation with suction), the cushion material of the present invention can be covered with a covering layer on its surface. For example, at least one surface of the cushion material can be covered by a fiber layer or a teflon layer to avoid the contamination from resin overflow and enhance the adsorbability to the carrying device. Preferably, the fiber layer is composed of a fiber selected from a group consisting of a PPTA fiber, a MPIA fiber, a heteroatom-containing aromatic fiber, an aromatic heterocyclic fiber, a graphitized carbon fiber, a novolac fiber (Kynol), a MF fiber, a PTFE fiber, a glass fiber, a Visit fiber and combinations thereof. However, a metal layer can also be used as the covering layer to increase the thermal conductivity of the cushion material. The said covering layers can be used alone or in combination optionally. Furthermore, there is no special limitation on the thickness of the covering layers as long as the desired performance can be provided. In some embodiments of the present invention, both surfaces of the cushion material are covered with a MPIA fiber layer with a thickness of about 75 nm.

The present invention further provides a method for manufacturing a laminate, comprising hot-pressing a plurality of build-up layers by a hot-pressing device, wherein a cushion material of the present invention is present between the hot-pressing device and the build-up layers. Depending on the types of the hot-pressing device used, the cushion material can be configured in any suitable manner (such as directly coming into contact or not coming into contact with the build-up layers) to uniformly transfer the pressure and heat to the surface of the build-up layers to obtain a laminate with good precision.

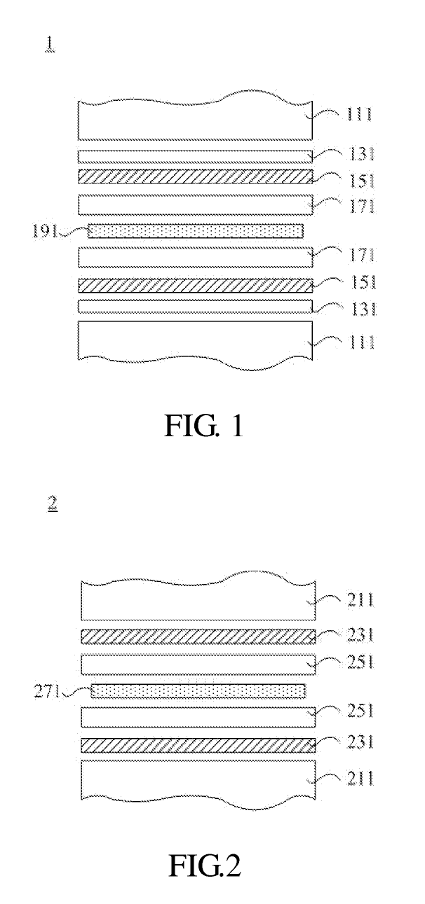

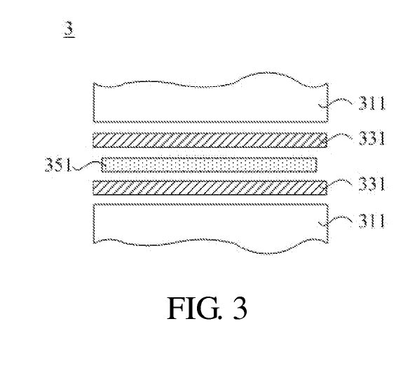

For example, in hot-press 1 of FIG. 1, cushion materials 151 are disposed between carrier plates 131 and steel plates 171, and in hot-press 2 of FIG. 2, cushion materials 231 are disposed between heating plates 211 and steel plates 251 without coming into contact with build-up layers 271. Alternatively, as shown in hot-press 3 of FIG. 3, cushion materials 351 may be disposed between heating plates 311 and build-up layers 351. The hot-presses and the configuration of the cushion materials shown in FIGS. 1 to 3 are provided for illustration but not to limit the application of the cushion material of the present invention. For example, the cushion materials can be disposed between the heating plates and the steel plates and between the steel plates and build-up layers at the same time.

The present invention will be further illustrated by the embodiments hereinafter.

### EXAMPLES

<The Preparation of Cushion Materials>

### Example 1

A fibrous net composed of MPIA fiber was applied as the substrate and PPTA fiber was applied as the fiber material. Pre-needle-punched cushion sheets were prepared via the steps of opening, blending, lapping, carding, pre-needle-punching. A plurality of cushion sheets were superimposed and then subjected to needle-punching (46500 needles), hot-pressing and singeing to provide a cushion material 1 with a basis weight of about 1600 g/m². The measured thermal conductivities of cushion material 1 at 20° C. and 160° C. were respectively 0.0915 W/m·K and 0.2651 W/m·K.

### Example 2

A cushion material 2 was prepared by covering both surfaces of cushion material 1 with a MPIA fiber layer with a thickness of about 75 nm.

### Example 3

The preparation steps of Example 1 were repeated for preparing a cushion material 3, except for using 90 wt % of PPTA fiber and 10 wt % of MPIA fiber as the fiber material.

### Example 4

A cushion material 4 was prepared by covering both surfaces of cushion material 3 with a MPIA fiber layer.

### Example 5

The preparation steps of Example 1 were repeated for preparing a cushion material, except for using 60 wt % of PPTA fiber and 40 wt % of MPIA fiber as the fiber material. Both the surfaces of the prepared cushion material were covered with a MPIA fiber layer with a thickness of about 75 nm to obtain a cushion material 5.

### Comparative Example 1

The preparation steps of Example were repeated for preparing a cushion material, except for using MPIA fiber alone as the fiber material. Both the surfaces of the prepared cushion material were covered with a MPIA fiber layer with a thickness of about 75 nm to obtain a cushion material F.

### Comparative Example 2

16 pages of kraft papers were superimposed to obtain a cushion material 2′.

<The Preparation of Laminates>

7628 glass fiber cloths were coated with an epoxy resin to provide prepregs (resin/glass fiber cloth: 43%). Eight pieces of the prepregs were superimposed and two copper foils (1 oz) were respectively superimposed on the two external surfaces of the superimposed prepregs to provide build-up layers. A hot-pressing operation was performed onto the build-up layers to provide a laminate by using hot-press 1 of FIG. 1, wherein cushion materials 1 to 5, 1′ and 2′ were respectively used as the cushion material 151. The hot-pressing conditions are as follows: in the pressure-reducing environment of 30 mmHg and under the full impressing pressure of 15 kg/m² (the initial impressing pressure is 8 kg/m²), raising the temperature from room temperature to 180° C. and keeping the temperature for 20 minutes; then raising the temperature from 120° C. to 180° C.; and finally raising the temperature again to 200° C. and keeping the temperature for 40 minutes. Each of the cushion materials was used to prepare 20 pieces of laminates and the average temperature rising rates of the cushion materials in the ranges of 50° C. to 120° C. and 120° C. to 180° C. were measured respectively. The properties of the obtained laminates, i.e., thickness difference (the center thickness of the laminate—the corner thickness of the laminate), glass transition temperature (Tg) and size shrinkage were measured, averaged and recorded in Table 1. Among which, the kraft papers (cushion material 2′) became brittle after 2 or 3 rounds, and thus, only one operation result was recorded.

The size shrinkage in Table 1 was measured as follows: marking two anchor points on the laminate sample and then measuring the distance change therebetween after etching and drying the laminate.

| | | | cushion | cushion | cushion | cushion | cushion | cushion | cushion |
|---|---|---|---|---|---|---|---|---|---|
| Items | | unit | material 1 | material 2 | material 3 | material 4 | material 5 | material 1′ | material 2′ |
| fiber | PPTA fiber | % | 100 | 100 | 90 | 90 | 60 | — | — |
| material | MPIA fiber | % | — | — | 10 | 10 | 40 | 100 | — |
| fibrous layer | | | no | yes | no | Yes | yes | yes | — |
| basis weight | | g/m² | 1600 | 1600 | 1600 | 1600 | 1600 | 1600 | — |
| (disregarding the fiber layer) | | | | | | | | | |
| average | 50° C. to 120° C. | ° C./min | 1.40 | 1.45 | 1.43 | 1.45 | 1.55 | 1.6 | 1.4 |
| temperature | 120° C. to 180° C. | ° C./min | 1.00 | 0.95 | 0.98 | 0.95 | 0.94 | 0.92 | 1.1 |
| raising rate | | | | | | | | | |

| | | | | | | | | |
|---|---|---|---|---|---|---|---|---|
| average thickness difference | mil | <3 | <3 | <3 | <3 | <3 | 5 | 8 |
| Tg | ° C. | 173 | 171 | 172 | 171 | 171 | 170 | 171 |
| average size shrinkage | ppm | 25 | 35 | 28 | 36 | 36 | 38 | 87 |

As shown in Table 1, while using the cushion material of the present invention (cushion material 1 to 5) in the hot-pressing operation, the provided temperature raising rate is comparable to that of the kraft papers (cushion material 2′). In addition, the glass transition temperatures (Tg) of the laminates prepared by using the cushion materials of the present invention are also comparable to that of the laminate prepared by using kraft papers. Moreover, the thickness difference of the laminates prepared by using the cushion materials of the present invention are considerably smaller than that of the laminate prepared by using kraft papers or the cushion material where the fiber material was composed of MPIA fiber (cushion material 1′). This fact indicates that the cushion material of the present invention can effectively reduce the overflow of resin in the build-up layers during hot-pressing so that the thickness distribution of the prepared laminates is much more uniform and the contamination of the cushion materials can be reduced.

Moreover, as shown in FIG. 1, the size change of the laminates prepared by using the cushion materials of the present invention are smaller than that of the laminates prepared by using other cushion material (even far smaller than that of the laminate prepared by using kraft papers). This fact indicates that the laminates prepared by using the cushion materials of the present invention have highly compact structures and high crosslinkages.

In view of the above, the cushion material of the present invention is reusable and has a thermal conductivity comparable to kraft papers, and is capable of reducing the resin overflow of build-up layers during the hot-pressing operation. Thus, the laminate prepared by using the cushion material of the present invention is provided with not only a uniform thickness distribution but also a superior size stability.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A cushion material for hot-press, comprising:
a substrate; and
a fiber material having a thermal conductivity coefficient which is lower than about 0.15 W/m·K at about 20° C. and increases with increasing temperature, wherein the fiber material is needle-punched on the substrate.

2. The cushion material of claim 1, wherein the thermal conductivity coefficient of the fiber material is higher than about 0.20 W/m·K at about 160° C.

3. The cushion material of claim 1, wherein each of the fiber material and the substrate has a thermal degradation temperature and both the thermal degradation temperatures of the fiber material and the substrate are higher than 350° C.

4. The cushion material of claim 1, wherein the fiber material is essentially composed of a poly-paraphenylene terephthalamide fiber.

5. The cushion material of claim 1, wherein the fiber material is essentially composed of a poly-paraphenylene terephthalamide fiber and a fiber selected from a group consisting of a poly-metaphenylene isophtalamide (MPIA) fiber, a heteroatom-containing aromatic fiber, an aromatic heterocyclic fiber, a graphitized carbon fiber, a novolac fiber (Kynol), a melamine formaldehyde (MF) fiber, a polytetrafluoroethylene (PTFE) fiber, a Visit fiber and combinations thereof.

6. The cushion material of claim 5, wherein the fiber material is essentially composed of a poly-paraphenylene terephthalamide fiber and a poly-metaphenylene isophtalamide fiber, and the amount of the poly-metaphenylene isophtalamide fiber is about 5 wt % to about 45 wt % based on the total weight of the fiber material.

7. The cushion material of claim 1, wherein the substrate is substantially composed of a fiber selected from a group consisting of a poly-paraphenylene terephthalamide fiber, a poly-metaphenylene isophtalamide fiber, a heteroatom-containing aromatic fiber, an aromatic heterocyclic fiber, a graphitized carbon fiber, a novolac fiber, a melamine formaldehyde fiber, a polytetrafluoroethylene fiber, a glass fiber, a Visil fiber and combinations thereof.

8. The cushion material of claim 7, wherein the substrate is substantially composed of a poly-metaphenylene isophtalamide fiber.

9. The cushion material of claim 1, which has a basis weight of about 200 g/m² to about 3000 g/m².

10. The cushion material of claims 1, wherein at least one surface of the cushion material is further covered with a fiber layer, a teflon layer or a metal layer.

11. The cushion material of claim 10, wherein the fiber layer is substantially composed of a fiber selected from a group consisting of a poly-paraphenylene terephthalamide fiber, a poly-metaphenylene isophtalamide fiber, a heteroatom-containing aromatic fiber, an aromatic heterocyclic fiber, a graphitized carbon fiber, a novolac fiber, a melamine formaldehyde fiber, a polytetrafluoroethylene fiber, a glass fiber, a Visil fiber and combinations thereof.

12. A method for manufacturing a laminate, comprising hot-pressing a plurality build-up layers by a hot-pressing device, wherein the cushion material of claim 1 is present between the hot-pressing device and the build-up layers.
